(19) United States
(12) Patent Application Publication
(10) Pub. No.: US 2023/0037961 A1
(43) Pub. Date: Feb. 9, 2023

(54) SECOND TRIGGER PHRASE USE FOR DIGITAL ASSISTANT BASED ON NAME OF PERSON AND/OR TOPIC OF DISCUSSION

(71) Applicant: Lenovo (Singapore) Pte. Ltd., Singapore (SG)

(72) Inventors: Justin Michael Ringuette, Morrisville, NC (US); Sandy Collins, Durham, NC (US); Robert James Norton, JR., Raleigh, NC (US)

(21) Appl. No.: 17/395,367

(22) Filed: Aug. 5, 2021

(51) Int. Cl. G10L 15/187; G10L 25/51

(52) U.S. Cl. CPC G10L 15/187; G10L 25/51; G10L 2015/088

(57) ABSTRACT

In one aspect, a device may include at least one processor and storage accessible to the at least one processor. The storage includes instructions executable by the at least one processor to correlate a first trigger phrase for a digital assistant to a name of a person within a proximity to the device and/or a topic of discussion. Based on the correlation, the instructions are executable to set the digital assistant to decline to monitor for utterance of the first trigger phrase and instead monitor for utterance of a second trigger phrase that is different from the first trigger phrase.

### FIELD

The disclosure below relates to technically inventive, non-routine solutions that are necessarily rooted in computer technology and that produce concrete technical improvements. In particular, the disclosure below relates to techniques for using a second trigger phrase for a digital assistant based on one or more current relevancy parameters.

### BACKGROUND

As recognized herein, digital assistants as embodied in various types of electronic devices are often assigned a proper noun that is to be spoken as part of a wake-up phrase to invoke the digital assistant. However, as also recognized herein, sometimes that proper noun is not entirely unique and may also be the name of an actual person whose name might be spoken by others, leading to unintentional triggering of the digital assistant and possible digital privacy breaches. As further recognized herein, sometimes the digital assistant itself might be verbally referenced by a person without the person intending to invoke the digital assistant, which can also lead to unintentional triggering of the digital assistant. There are currently no adequate solutions to the foregoing computer-related, technological problem.

### SUMMARY

Accordingly, in one aspect a device includes at least one processor and storage accessible to the at least one processor. The storage includes instructions executable by the at least one processor to correlate a first trigger phrase for a digital assistant to one or more of a name of a person within a proximity to the device and/or a topic of discussion. Based on the correlation, the instructions are executable to set the digital assistant to decline to monitor for utterance of the first trigger phrase and instead monitor for utterance of a second trigger phrase that is different from the first trigger phrase.

Thus, in various example implementations the instructions may be executable to execute a command responsive to identification of utterance of the second trigger phrase and utterance of the command as spoken subsequent to the second trigger phrase.

Additionally, in various examples the instructions may be executable to make the correlation based on a phonetic match of at least part of the first trigger phrase to at least part of the name and/or topic. Additionally, or alternatively, the correlation may be made based on an actual match of the first trigger phrase to the name and/or topic itself.

Still further, if desired in some examples the instructions may be executable to present a notification indicating the second trigger phrase is operative for invoking the digital assistant based on the correlation.

In another aspect, a method includes correlating a first trigger phrase for a digital assistant to one or more of a name of a person within a proximity to a device and/or a topic of discussion. The method also includes, based on the correlation, setting the digital assistant to decline to monitor for utterance of the first trigger phrase and instead monitor for utterance of a second trigger phrase that is different from the first trigger phrase.

In various example implementations, within the proximity to the device may be within a threshold distance to the device.

Also in some example implementations, the device may be a first device, and the correlation may be made based at least in part on identification of a signal from a second device different from the first device. The second device may be associated with the person.

Additionally, in some examples the correlation may be made based at least in part on identification of a particular person being present within the proximity. The correlation may also be made based at least in part on a keyword identified from an electronic calendar entry and/or meeting invite.

Still further, if desired the first and second trigger phrases may each include at least one word. Thus, in some examples the first trigger phrase may include a proper noun and the second trigger phrase may include a common noun. Also in some examples, the first trigger phrase may include a proper noun but not a common noun, and the second trigger phrase may include a proper noun and a common noun.

In still another aspect, at least one computer readable storage medium (CRSM) that is not a transitory signal includes instructions executable by at least one processor to correlate a first wake up phrase for a digital assistant to a current relevancy parameter. The instructions are also executable to, based on the correlation, set the digital assistant to monitor for utterance of a second wake up phrase rather than the first wake up phrase. The second wake up phrase is different from the first wake up phrase.

In various examples, the current relevancy parameter may include a particular name of a person currently within a proximity to the device. The current relevancy parameter may also include a particular subject that is currently being discussed. The particular subject that is currently being discussed may be identified via execution of natural language processing on input from at least one microphone.

Additionally, in some example implementations the second wake up phrase may be a secondary wake up phrase that is not operative for invoking the digital assistant during times when the first wake up phrase is operative for invoking the digital assistant. In these implementations, the first wake up phrase may be a primary wake up phrase for invoking the digital assistant.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows example logic in example flow chart format that may be executed by a device consistent with present principles;

FIG. 4 shows an example graphical user interface (GUI) that may be used to notify one or more end users that a secondary wake up phrase is operative for invoking a digital assistant consistent with present principles; and

FIG. 5 shows an example GUI that may be presented to configure one or more settings of a device to operate consistent with present principles.

### DETAILED DESCRIPTION

Among other things, the detailed description below relates to electronic devices that can identify the names of people within an Internet of things (IoT) environment and avoid name collisions with a wake-up phrase for a digital assistant by switching to backup names/trigger phrases for the digital assistant that can help avoid such collisions.

Peoples' names may be identified through various methods including device tracking (e.g., user's smartphone alerts the local IoT device(s)), human presence detection, and calendar attendee lists. E.g., if an IoT device itself is an expected topic of discussion such as in a product meeting, the IoT device's trigger name (e.g., “Boris”) may be added as an attendee (a virtual person) to the attendee list for the meeting to instigate the wake-up phrase change to the backup phrase.

Thus, backup names/trigger phrases may replace collision names in the primary wake up phrase to help avoid potential collisions (e.g., the vacuum “Boris” may be renamed to “Vacuum 1”). Additionally, or alternatively, the backup names/trigger phrases may be of increased complexity to help avoid potential collisions (e.g., the vacuum “Boris” may be renamed “Vacuum Boris”).

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

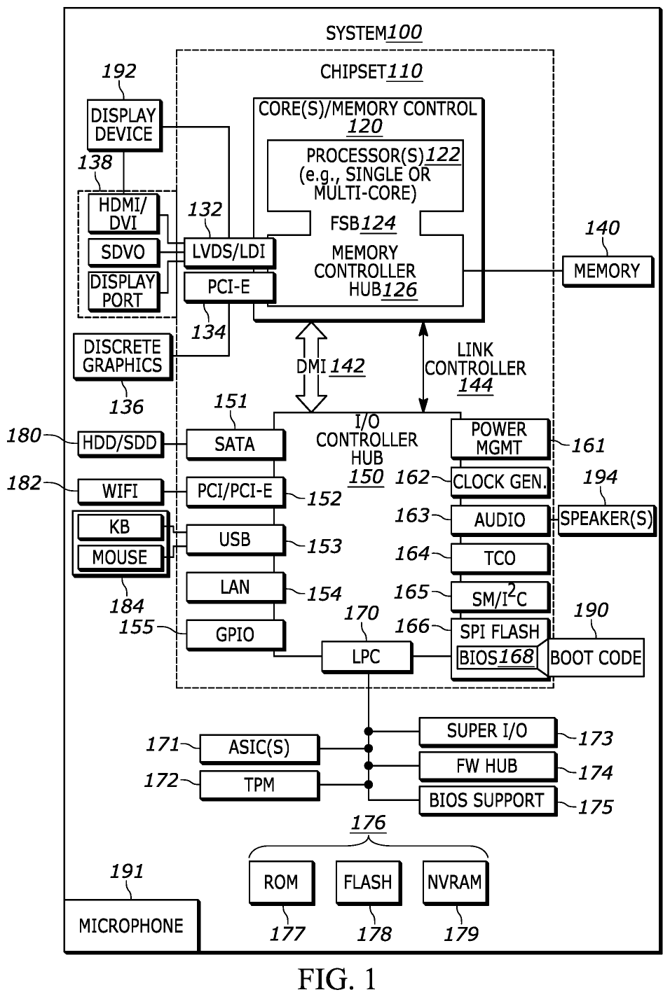

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing, or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may include an audio receiver/microphone 191 that provides input from the microphone 191 to the processor 122 based on audio that is detected, such as via a user providing audible input to the microphone 191 to trigger a digital assistant executing at the system 100 consistent with present principles.

Though not shown for simplicity, the system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video. Additionally, in some embodiments the system 100 may include a gyroscope that senses and/or measures the orientation of the system 100 and provides related input to the processor 122, as well as an accelerometer that senses acceleration and/or movement of the system 100 and provides related input to the processor 122.

Also, the system 100 may include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

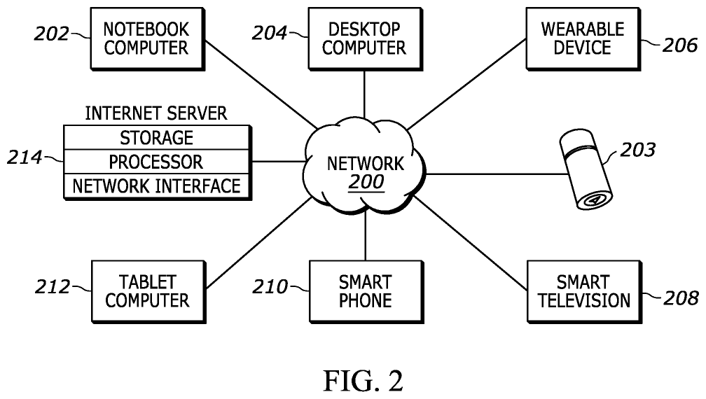

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a stand-alone digital assistant Internet of things (IOT) device 303, a desktop computer 204, a IoT wearable device 206 such as a smart watch, an IoT smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

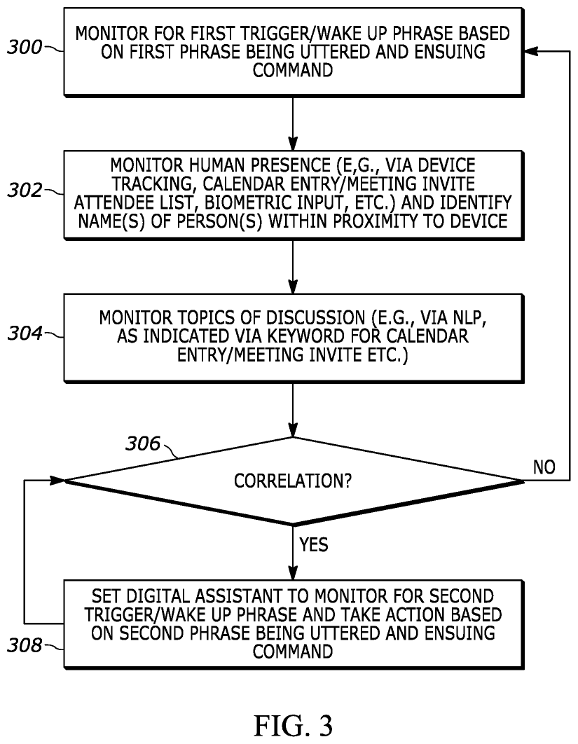

Note before moving on to FIG. 3 that the IoT device 303, and indeed any of the devices disclosed herein, may execute a digital assistant locally and/or in conjunction with a remotely-located server to process voice input from a user to a local microphone, such as a microphone on the respective device itself. The digital assistant may be executed consistent with the principles described further below and may be similar to, for example, Amazon's Alexa, Apple's Siri, or Google's Assistant.

Referring now to FIG. 3, it shows example logic that may be executed by a first device such as the system 100 or device 303 executing a digital assistant consistent with present principles. Note that while the logic of FIG. 3 is shown in flow chart format, state logic or other suitable logic may also be used.

Beginning at block 300, the first device may use its microprocessor, central processing unit (CPU), digital signal processor (DSP), or other suitable processor to execute the digital assistant to monitor for a first trigger/wake up phrase. During this time, should a user utter the first trigger phrase, the digital assistant will be cued that ensuing voice input from the user will include a command on which the digital assistant is to act. Thus, action may be taken at block 300 in conformance with such voice input as provided after utterance of the first trigger phrase itself. The action might include, for example, providing requested information to the user, operating the device itself in conformance with the command (e.g., vacuuming if the device is a vacuum), sending a message, playing music, etc.

From block 300 the logic may proceed to block 302. At block 302 the first device may monitor its proximity for human presence and identify the names of any people determined to be proximate. Proximity may be established as within a threshold distance to the first device, such as within a threshold radius establishing a three-dimensional spherical area around the first device.

One example way in which the first device may monitor its proximity for human presence is by tracking other devices via wireless Wi-Fi, Bluetooth, or other signals to identify different respective people associated with different respective devices for which signals are received. Thus, information from the signals such as IP address, MAC address, network address, or device network name may be correlated to the names of the respective people themselves using a relational database that correlates such information.

To determine whether the other device being tracked by wireless signal is within the proximity to the first device, the first device may use the other device's current location as reported in the received signals themselves (e.g., in GPS coordinates) and compare that location to the first device's own current location to determine a distance between the two devices. Additionally, or alternatively, a received signal strength indicator (RSSI) algorithm may be executed to determine a distance to the other device based on the strength of the signals being received from it. Triangulation may also be used if the first device has two wireless transceivers spaced apart from each other and/or if the first device can communicate with a third device having a known location to triangulate the signal from the other device coming within the proximity. Or the first device may simply assume that signal detection implicates the other device being within the proximity.

Another example way in which the first device may monitor for human presence at block 302 to identify one or more people within its proximity is by tracking current time of day and data in an electronic calendar entry or meeting invite to identify attendees via an invite list for the associated meeting itself (as indicated in the calendar entry/invite). The first device may thus assume the presence of the invited attendees during the scheduled meeting time if the first device determines it is also currently at or within a threshold distance to the meeting's location (as may also be indicated in the calendar entry/invite). GPS coordinates may be used for determining the current location of the first device, for example.

As yet another example, at block 302 the device may receive input from one or more biometric sensors to identify proximate people based the input. For example, voice recognition may be executed on input from a microphone, and/or facial recognition may be executed on input from a digital camera, to identify various people by name and assume that they are within the proximity based on their detection.

From block 302 the logic may proceed to block 304. At block 304 the first device may monitor topics of discussion amongst the proximate people and/or user of the first device. Additionally or alternatively, even if the user is alone at a given location, the first device may execute block 304 responsive to the user initiating or accepting a telephone call or video call with a remote person (using the first device or another device), responsive to the user initiating a podcast recording or other recording via a voice recording application to record words spoken by the user, or responsive to the user providing voice input as part of execution of another application such as for voice-recognition text entry to a text messaging application.

The topic(s) of discussion themselves may that are to be monitored for may be identified a number of different ways. For example, natural language processing (NLP), and sometimes natural language understanding (NLU) specifically, may be executed on input from the first device's microphone or another local microphone to identify one or more topics or keywords from people's speech to potentially correlate that topic or keyword to the first trigger phrase itself (e.g., the topic/keyword matches the first trigger phrase in whole or phonetically in part).

The aforementioned calendar entry and/or meeting invite may also be accessed at block 304 to determine, using NLP and/or keyword correlation, whether data indicated for the subject of the meeting (or data in the meeting notes) indicates a topic/keyword that can be correlated to the first trigger phrase. For example, if the digital assistant itself is an expected topic of discussion, the assistant's proper name trigger (e.g., “Boris”) may be added as an attendee (a virtual person) to the attendee list/calendar entry to instigate the first device to then assume the presence of the virtual person named “Boris” and hence switch to use of a backup trigger phrase during the meeting to avoid name collisions based on utterances of “Boris”.

From block 304 the logic may proceed to decision diamond 306 where the first device may actually determine if one or more correlations can be made. Again, note that the correlation may be of the first trigger phrase for the digital assistant to a current relevancy parameter such as one or more names of one or more people within a proximity to the device and/or one or more topics of discussion as set forth above. A negative determination may cause the logic to proceed back to block 300 and proceed therefrom.

However, an affirmative determination may instead cause the logic to proceed to block 308 where the first device may, based on the correlation(s), set the digital assistant/device processor to decline to monitor for utterance of the first trigger phrase and instead monitor for utterance of a second trigger/wake up phrase that is different from the first trigger phrase. Also at block 308, responsive to identification of utterance of the second trigger phrase and utterance of an ensuing command spoken subsequent to the second trigger phrase, the first device execute the command itself.

Regarding the second trigger phrase, note that it may be a secondary trigger/wake up phrase that is not operative for invoking the digital assistant during times when the first trigger phrase is operative for invoking the digital assistant. The first trigger phrase may thus be a primary trigger/wake up phrase for invoking the digital assistant during most times, and the second trigger phrase may be a “backup” trigger phrase.

Also note that each of the first and second trigger phrases may include at least one word. In some examples, the first trigger phrase may include a salutation and a proper noun (such as “Hey Boris”) and the second trigger phrase may include the same salutation and a common noun (such as “Hey vacuum” or “Hey vacuum 1”). However, in other examples the first trigger phrase may include a proper noun but not a common noun (“Hey Boris” again), and the second trigger phrase may include a proper noun and a common noun (“Hey vacuum Boris”) that may be required to be spoken in a particular proper/common noun sequence to trigger the digital assistant itself.

Referring back to phonetic matches to part but not all of a given primary trigger phrase as referenced above, note that a phonetic match of a trigger phrase to a name or topic/subject of discussion may be determined if, for example, a phonetic match to consecutive syllables of the trigger phrase can be identified for at least two consecutive syllables of the name and/or topic to avoid false positives causing a switch to the secondary wake up phrase based on a single-syllable phonetic match for a multi-syllable trigger phrase. Phonetic matches may be determined using text to speech software, an online dictionary or other reference indicating pronunciations for respective words/names, etc. For single-syllable trigger phrases, in various examples an actual match of the trigger phrase to the name/topic itself may still be required for switching to the secondary trigger phrase.

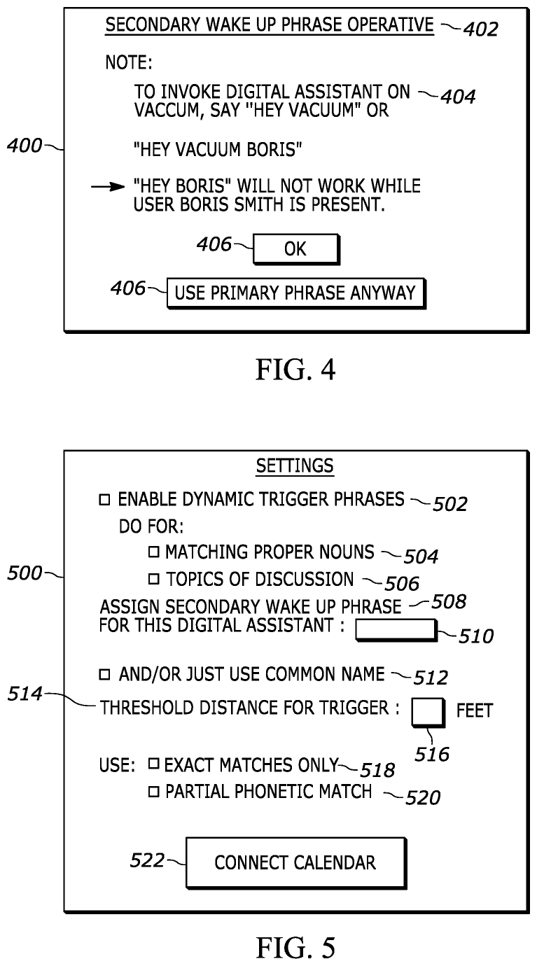

Still in reference to FIG. 3 and also at block 308, note that the first device may, based on the correlation, also present a notification indicating the second trigger phrase is operative for invoking the digital assistant. An example of such a notification is shown in FIG. 4.

Accordingly, reference is now made to FIG. 4, which shows an example graphical user interface (GUI) 400 that may be presented on the display of the first device or on another display within the proximity to the first device (such as a wall-mounted television within a conference room, the display of an IoT hub/coordinating device, or the display of a designated user's smartphone). As shown, the GUI 400 may include a prompt 402 that a secondary wake up phrase is currently operative for invoking a digital assistant of an IoT smart vacuum (the first device in this example).

The GUI 400 may also include a note 404 that to invoke the digital assistant on the IoT smart vacuum, the user should utter either of the aforementioned secondary wake up phrases “Hey vacuum” or “Hey vacuum Boris”. As also shown, the note 404 may further indicate that the primary wake up phrase “Hey Boris” will not work to invoke the digital assistant to execute an ensuing voice command while a person identified as being named Boris Smith is present/within the proximity to the vacuum as determined using one or more of the methods disclosed above. Thus, in this example and while the secondary wake up phrases are operative, there will not be a name collision between invoking the vacuum's digital assistant and a person trying to get Boris Smith's attention by uttering “Hey Boris”.

Also, per FIG. 4, the user may direct touch or cursor input to the “ok” selector 406 on the GUI 400 to acknowledge the notification and dismiss the GUI 400. However, if for some reason the user still prefers to use the primary wake up phrase to invoke the digital assistant even under the identified condition(s), the user may instead select the selector 408 to set the digital assistant to decline to monitor for utterance of the secondary wake up phrases and instead monitor for utterance of the primary wake up phrase.

Additionally, note with respect to the notification of FIG. 4 that one or more aspects of the GUI 400 may be read aloud using the digital assistant itself or another voice generation engine such as text to speech software. For example, the text of the GUI 400 may be read aloud through a speaker on the IoT device, or a speaker located elsewhere within the proximity to audibly provide the notification.

Continuing the detailed description in reference to FIG. 5, it shows an example settings GUI 500 that may be presented on a display to configure one or more settings of a device to operate its digital assistant consistent with present principles. For example, the GUI 500 may be presented based on a user navigating a settings menu of the device to arrive at the GUI 500, or based on receipt of a voice command to present the GUI 500. Note that each of the options or sub-options to be discussed below may be selected by an end user based on the user directing touch or cursor input to the check box adjacent to the respective option.

As shown in FIG. 5, the GUI 500 may include a first option 502 that may be selectable to set or configure the device to undertake present principles. For example, the option 502 may be selected a single time to set or enable the device to, for multiple instances in the future, execute the logic of FIG. 3 to use one or more secondary trigger phrases rather than a primary trigger phrase for a digital assistant based on detection of one or more current relevancy parameters as set forth above (e.g., a name match or currently-discussed topic match). If desired, the option 502 may be accompanied by a sub-option 504 for the device to do so only when the primary trigger phrase matches names/proper nouns of proximate people, and a sub-option 506 for the device to do so only when the primary trigger phrase matches an identified topic of discussion.

Additionally, the GUI 500 may include a setting 508 at which the end user may establish a particular secondary trigger phrase for the respective device's digital assistant. For example, the end user may enter the desired secondary trigger phrase into text input box 510 using a hard or soft keyboard in order to set the secondary trigger phrase according to the text input itself. For further customization, in some examples the end user might select option 512 to additionally or alternatively use the associated device's common name as the secondary trigger phrase (e.g., “vacuum” for an IoT vacuum, or “smart phone” for a smart phone embodying the digital assistant).

Still further, the GUI 500 may include a setting 514 at which the end user can specify the threshold distance to be used for determining proximity to the device consistent with present principles. For example, the end user may enter the desired distance into number input box 516 using a hard or soft keyboard in order to set the threshold distance according to the number input.

Still in reference to FIG. 5, as also shown the GUI 500 may include an option 518 to set the device to only use a secondary trigger phrase to trigger the device's digital assistant responsive to a match of all of a name and/or topic of discussion to the primary trigger phrase (e.g., phonetically matches all syllables of the primary trigger phrase). However, the option 520 may instead be selected to set the device to use the secondary trigger phrase(s) responsive to a partial phonetic match of the name or topic to the primary trigger phrase as described above.

As also shown in FIG. 5, the GUI 500 may include a selector 522. The selector 522 that may be selectable to link or connect a particular electronic calendar to the device and/or digital assistant so that the device/assistant can access data for one or more calendar entries and/or meeting invites as described above.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A device, comprising:
at least one processor; and
storage accessible to the at least one processor and comprising instructions executable by the at least one processor to:
correlate a first trigger phrase for a digital assistant to one or more of: a name of a person within a proximity to the device, and a topic of discussion; and
based on the correlation, set the digital assistant to decline to monitor for utterance of the first trigger phrase and instead monitor for utterance of a second trigger phrase that is different from the first trigger phrase.

2. The device of claim 1, wherein the instructions are executable to:
correlate the first trigger phrase for the digital assistant to a name of a person within a proximity to the device; and
based on the correlation, set the digital assistant to decline to monitor for utterance of the first trigger phrase and instead monitor for utterance of the second trigger phrase.

3. The device of claim 1, wherein the instructions are executable to:
correlate the first trigger phrase for the digital assistant to a topic of discussion; and
based on the correlation, set the digital assistant to decline to monitor for utterance of the first trigger phrase and instead monitor for utterance of the second trigger phrase.

4. The device of claim 1, wherein the instructions are executable to:
responsive to identification of utterance of the second trigger phrase and utterance of a command spoken subsequent to the second trigger phrase, execute the command.

5. The device of claim 1, wherein the instructions are executable to:
make the correlation based on a phonetic match of at least part of the first trigger phrase to at least part of the name and/or topic.

6. The device of claim 1, wherein the instructions are executable to:
make the correlation based on a match of the first trigger phrase to the name and/or topic.

7. The device of claim 1, wherein the instructions are executable to:
based on the correlation, present a notification indicating the second trigger phrase is operative for invoking the digital assistant.

8. A method, comprising:
correlating a first trigger phrase for a digital assistant to one or more of: a name of a person within a proximity to a device, and a topic of discussion; and
based on the correlation, setting the digital assistant to decline to monitor for utterance of the first trigger phrase and instead monitor for utterance of a second trigger phrase that is different from the first trigger phrase.

9. The method of claim 8, wherein within the proximity to the device is within a threshold distance to the device.

10. The method of claim 8, wherein the device is a first device, and wherein the correlation is made based at least in part on identification of a signal from a second device different from the first device, the second device associated with the person.

11. The method of claim 8, wherein the correlation is made based at least in part on identification of a particular person being present within the proximity.

12. The method of claim 8, wherein the correlation is made based at least in part on a keyword identified from an electronic calendar entry and/or meeting invite.

13. The method of claim 8, wherein the first and second trigger phrases each comprise at least one word.

14. The method of claim 8, wherein the first trigger phrase comprises a proper noun, and wherein the second trigger phrase comprises a common noun.

15. The method of claim 8, wherein the first trigger phrase comprises a proper noun but not a common noun, and wherein the second trigger phrase comprises a proper noun and a common noun.

16. At least one computer readable storage medium (CRSM) that is not a transitory signal, the computer readable storage medium comprising instructions executable by at least one processor to:
correlate a first wake up phrase for a digital assistant to a current relevancy parameter; and
based on the correlation, set the digital assistant to monitor for utterance of a second wake up phrase rather than the first wake up phrase, the second wake up phrase being different from the first wake up phrase.

17. The CRSM of claim 16, wherein the current relevancy parameter comprises a particular name of a person currently within a proximity to the device.

18. The CRSM of claim 16, wherein the current relevancy parameter comprises a particular subject that is currently being discussed.

19. The CRSM of claim 18, wherein the particular subject that is currently being discussed is identified via execution of natural language processing on input from at least one microphone.

20. The CRSM of claim 16, wherein the second wake up phrase is a secondary wake up phrase that is not operative for invoking the digital assistant during times when the first wake up phrase is operative for invoking the digital assistant, the first wake up phrase being a primary wake up phrase for invoking the digital assistant.
